(19) United States
(12) Patent Application Publication
(10) Pub. No.: US 2011/0267350 A1
(43) Pub. Date: Nov. 3, 2011

(54) Adaptive Process Simplification of Mined Business Process Graphs Using Tutte Parameterizations

(75) Inventors: Francisco Phelan Curbera, Hawthorne, NY (US); Geetika Tewari Lakshmanan, Cambridge, MA (US)

(73) Assignee: International Business Machines Corporation, Armonk, NY (US)

(21) Appl. No.: 12/770,067

(22) Filed: Apr. 29, 2010

(51) Int. Cl. G06T 11/20

(52) U.S. Cl. 345/440

(57) ABSTRACT

A method of graph simplification includes receiving a connected process graph having a plurality of edges and nodes, parameterizing the connected process graph to determine a mapping where none of the edges overlap, defining respective energies for a plurality of triangles formed by the edges and the nodes in the connected process graph, identifying node clusters in the connected process graph, and collapsing, for each node cluster, ones of the edges and nodes in the connected process graph that are not critical edges or critical nodes according to the energies.

### BACKGROUND

1. Technical Field

The present invention relates generally to simplifying the visualization and data structure used to embody unstructured process graphs.

2. Discussion of Related Art

Discovered process models are representations of a particular process that typically show all details without distinguishing between what is important and what is not. For example, mined process graphs can be very complicated and detailed with thousands of overlapping process edges.

A frequently used algorithm for addressing the problem of simplifying mined process graphs is known as Fuzzy Mining, developed by Gunther et al. While the Fuzzy Mining approach successfully shows a number of simplified views of mined process graphs, it requires a user to initialize a number of parameters. These parameters classify the importance of an edge and the importance of a node in terms of their connectivity and their business context. Specifically the Fuzzy Mining algorithm requires the user to specify metrics for (1) Unary Significance, (2) Binary Significance and (3) Binary Correlation.

Unary significance can be defined in terms of how frequently events occur as well as points at which a process forks or events synchronize to one. Binary significance describes the relative importance between two event classes. Binary correlation measures the magnitude of context changes.

The Fuzzy Mining algorithm successively removes edges and vertices of low importance until it arrives at a simplified view of the mined process graph. Removing topology and semantically relevant information permanently from the graph can be problematic.

Therefore, a need exists for a method of simplifying unstructured processes.

### BRIEF SUMMARY

According to an embodiment of the present disclosure, a method of graph simplification includes receiving a connected process graph having a plurality of edges and nodes, parameterizing the connected process graph to determine a mapping where none of the edges overlap, defining respective energies for a plurality of triangles formed by the edges and the nodes in the connected process graph, identifying node clusters in the connected process graph, and collapsing, for each node cluster, ones of the edges and nodes in the connected process graph that are not critical edges or critical nodes according to the energies.

According to an embodiment of the present disclosure, a computer program product for rendering a connected process graph includes a computer readable storage medium having computer readable program code embodied therewith. The computer readable program code includes computer readable program code configured to receive the connected process graph having a plurality of edges and nodes, computer readable program code configured to parameterize the connected process graph to determine an injective mapping where none of the edges overlap, computer readable program code configured to define respective energy functions for a plurality of triangles formed by the edges and the nodes in the connected process graph, computer readable program code configured to identify node clusters in the connected process graph, and computer readable program code configured to collapse, for each node cluster, ones of the edges and nodes in the connected process graph that are not critical edges or critical nodes according to the energy functions.

A method for manipulating a connected process graph having a plurality of edges and nodes, includes identifying node clusters in the connected process graph, wherein the connected process graph has an injective mapping where none of the edges overlap, and wherein at least one polygon formed by the nodes in the connected process graph is associated with an energy function, selecting a node cluster of interest, and collapsing, for the node cluster of interest, ones of the edges and nodes in the connected process graph that are not critical edges according to the energy function.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a graph illustrating examples of critical nodes according to an exemplary embodiment of the present disclosure;

FIG. 2A is an exemplary input graph according to an embodiment of the present disclosure;

FIG. 2B is an exemplary Tutte embedding of the graph of FIG. 2A;

FIG. 3 illustrates an example of edge-collapse and vertex-split according to an embodiment of the present disclosure;

FIG. 4 is a flow chart of a method of simplifying an unstructured process according to an embodiment of the present disclosure.

FIG. 5 is illustrates low energy clusters in an exemplary graph according to an embodiment of the present disclosure;

FIGS. 6A-J illustrate a method of simplifying an unstructured process given the graph of FIG. 4 as input according to an embodiment of the present disclosure; and

FIG. 7 is a diagram of a computer system simplifying the visualization and data structure used to embody unstructured process graphs according to an embodiment of the present disclosure.

### DETAILED DESCRIPTION

According to exemplary embodiments of the present disclosure, mined process graphs, such as business process graphs, are simplified, allowing a user to view a mined process graph at different levels of details using a progressive mesh based on injective parameterizations. An initial process view displayed to a user may show an injective embedding, with no overlapping edges, of the mined process graph in 2D. Further, clutter is removed from the mined process graph, allowing the user to expand or contract areas of the process graph that they wish to focus on.

According to exemplary embodiments of the present disclosure, a simplification method takes into account topology, 2D surface area, and semantic meaning of edges in a process graph, automatically identifies critical edges and critical nodes that will not get eliminated during the simplification process, does not permanently remove edges or nodes, does not disconnect the graph by automatically detecting a critical path in congested areas of the graph, allows the user to select areas of the graph to simplify, and shows an injective embedding of the mined process graph which by definition has no overlapping edges. In this description the terms vertex and node are used interchangeably.

The input is a mined process graph. The process graph may have thousands of nodes and edges. It is assumed that the graph is connected. In a connected graph, if a graph traversal (such as depth first search or breadth first search) begins at any node in the graph, one should be able to reach any other node in the graph.

According to exemplary embodiments of the present disclosure, a method allows the user to view the mined process graph and identify and annotate critical edges and nodes. An editable display allows the user to click and select important nodes and edges. Importance may be determined by a user and relates to the process. The selected nodes and edges are added to lists, for example, a Critical_Nodes list and a Critical_Edges list, respectively. These critical nodes and edges are ones that cannot be removed from the graph during the simplification procedure. Examples of critical nodes include source nodes in the process graph where the process begins, such as a node representing the intake of patient information in a health care process. Process termination nodes in the graph can also be critical nodes; using the health care example, a node representing patient discharge from a hospital may be a termination node. Nodes that represent activities that execute in parallel can also be added to the list of critical nodes. For a process, critical nodes may represent a set of nodes in the process that represent the core elements of the business process. The edges that connect these critical nodes can be edges on paths that represent the most frequent executions of the process. In this case, these edges can be part of the list of critical edges. The process simplification procedure described in this disclosure substantially ensures that elements that are critical to a process are not removed during the process simplification procedure. The end result is an automatically simplified process graph that maintains important aspects of the process and hides less relevant details.

Referring now to the figures; the flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

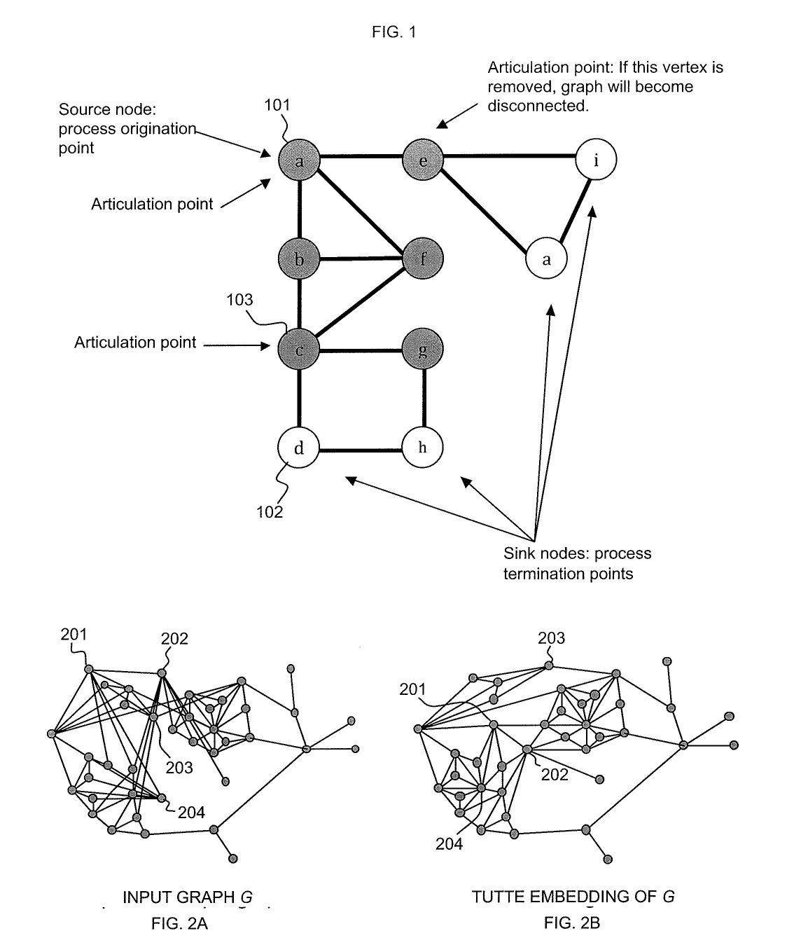

Referring to FIG. 1, a source node 101 denotes the beginning of the process graph. A sink node 102 could be the last node in one potential execution of the graph.

The identification of critical nodes and edges is optional. For example, if a user is unfamiliar with the business process, and by extension the process graph, or if the graph is too complicated, the identification may be omitted.

As an alternative to the user selection of critical nodes and edges, the method may include automatic detection of critical nodes and edges. One or more graph methods may be used to detect important nodes in the graph. In one embodiment of the present disclosure, importance may be defined in terms of connectivity. Nodes and edges whose removal leads the graph to become disconnected should be marked as important. The automatic detection of critical nodes and edges may include a depth first search of the process graph, the identification of articulation points, and the detection of source and sink vertices in the process graph.

An articulation point 103 is a point in a graph, which if removed, causes the graph to become disconnected (see FIG. 1). The method adds the edges connected to articulation points to the list of critical vertices and/or edges, L_{c}(e,v), in the graph and adds the vertices to this list as well L_{c}(e,v).

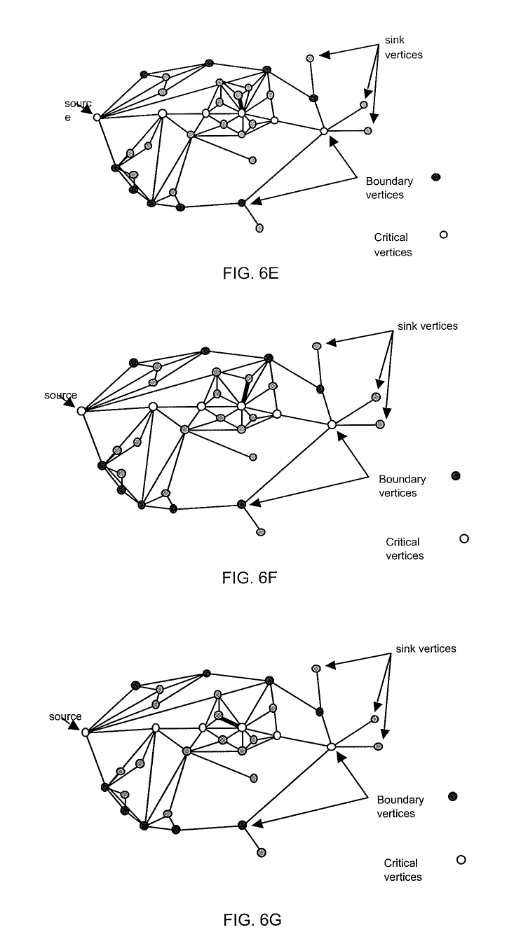

To automatically detect source and sink vertices in the process graph, the method iterates through the list of vertices, and determines all vertices which only have one edge connecting them. Such a vertex must either be a source or a sink. Also, when constructing the graphs, mark vertices which serve as process initiation or process termination points. A process initiation point is a source vertex, and a process termination point is a sink vertex. All edges connected to these vertices should be added to the critical edge list, L. The process graph is parameterized using the Tutte method (W. T. Tutte. How to draw a graph. Proceedings of the London Mathematical Society, 13(3):743-768, 1963.). Let V represent the total number of vertices in the graph. Boundary vertices are identified and sorted in the order in which they are encountered during a traversal on the boundary. Let B denote the list of boundary vertices. Exclude vertices from the boundary which are sink or source vertices that only have one edge connecting them to the rest of the graph. FIG. 5 shows an example of boundary vertices marked on a sample graph.

Boundary vertex coordinates are determined.

Equation 1 represents the x-coordinate of a vertex i on the boundary.

xᵢ=bᵢ^{x},i=V−B+1, . . . , V (1)

Equation 2 represents the y-coordinate of a vertex i on the boundary.

yᵢ=bᵢ^{y},i=V−B+1, . . . , V (2)

Boundary vertices are assigned coordinates on a circle. Coordinates are assigned by using the parametric coordinates for a point on a circle. Equation (3) shows the x-coordinate for a point on a circle whose origin is at (j,k), and whose radius is r, and θ is the angle from 0 at which the point is situated. Equation (4) shows the y-coordinate for this point.

x(θ)=r cos(θ)+j (3)

y(θ)=r sin(θ)+k (4)

In order to assign coordinates the angle, θ from 0 at which the point is to be situated is determined. θ is obtained as follows. For the first boundary point i, the angle θᵢ needed to compute its boundary coordinates is:

$${θ}_{i} = \frac{360}{\vert B \vert} \qquad ( 5 )$$

where in Equation (5), |B| represents the size or cardinality of the set of boundary vertices.

For any other nth boundary point which is not the first boundary point, the angle θₙ needed to compute its boundary coordinates is:

$${θ}_{n} = \frac{360}{\vert B \vert} + {\sum }_{i = 1}^{n - 1} {θ}_{i} \qquad ( 6 )$$

The term on the right side of the plus sign in equation (6) represents the sum of the angles theta computed for boundary vertices 1 to (n−1). It is assumed that r=1, and that the origin (j,k) is (0,0).

The method solves a Tutte system for interior vertex coordinates. A system of equations is set up as defined by Tutte and solved in order to obtain the coordinates of the interior vertices in the graph. Interior vertices are vertices that are not on the boundary. A Tutte embedding ensures that these vertices as well as the edges connecting them are non-overlapping. Tutte creates an embedding by solving the following linear system for the xᵢ and yᵢ coordinates of an interior vertex i:

$${\sum }_{{v}_{j} ∈ N ( {v}_{i} )} {w}_{ij} {x}_{j} = {x}_{i} , i = 1 , … , V - B \qquad ( 7 )$$

In equation 7, xᵢ is the x-coordinate of vertex vᵢ, and xⱼ is the x-coordinate of vertex vⱼ, and wᵢⱼ is a weight whose value is between 0 and 1, and vⱼ is a vertex in the neighborhood, N(vᵢ), of vᵢ. Neighborhood of a vertex vᵢ consists of all vertices vⱼ which are connected to vᵢ by a single edge in the graph G.

$${\sum }_{{v}_{j} ∈ N ( {v}_{i} )} {w}_{ij} {y}_{j} = {y}_{i} , i = 1 , … , V - B \qquad ( 8 )$$

In equation 7, yᵢ is the y-coordinate of vertex vᵢ, and yⱼ is the y-coordinate of vertex vⱼ and wᵢⱼ is a weight whose value is between 0 and 1, and vⱼ is a vertex in the neighborhood, N(vᵢ), of vᵢ. Neighborhood of a vertex vᵢ consists of all vertices vⱼ which are connected to vᵢ by a single edge in the graph G.

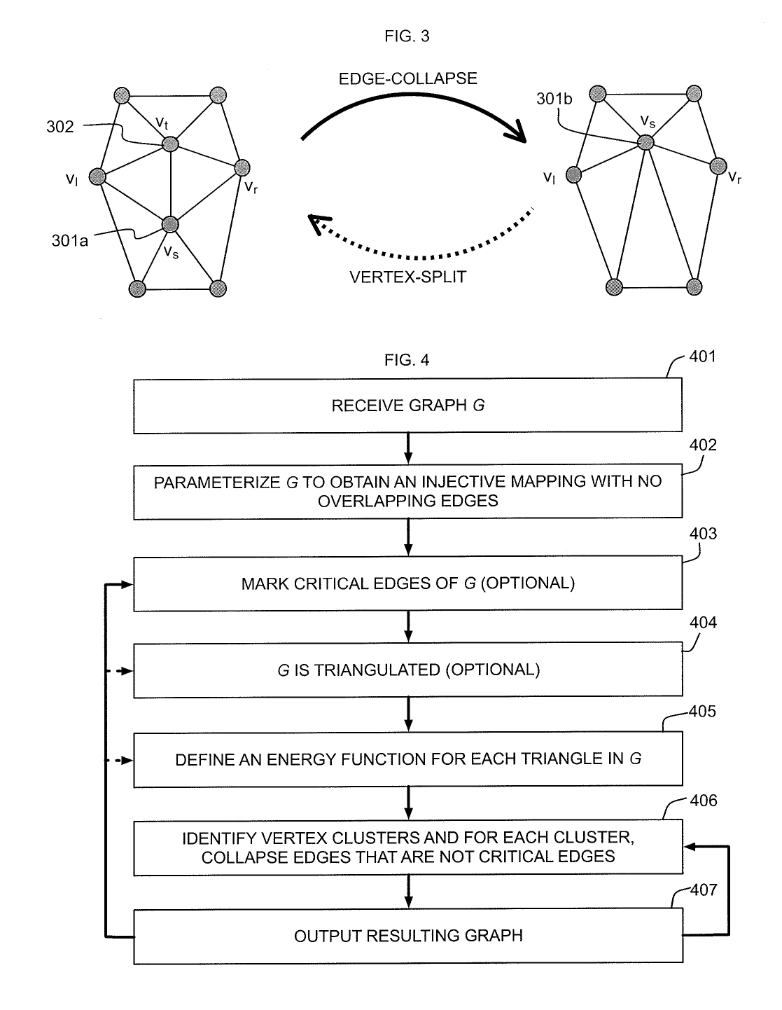

FIG. 2A shows an example of a graph, while FIG. 2B shows its Tutte embedding. In FIG. 2A, the graph includes overlapping edges. The graph of FIG. 2B has no overlapping edges. Comparing FIGS. 2A and 2B, vertices 201-204 are moved as a result of the Tutte embedding to provide an injective (non-overlapping) parameterization of the graph.

The method may include a triangulation or polygonalization of the process graph. If the user wishes, they may triangulate the graph using any triangulation method such as Delaunay Triangulation (typically, a Delaunay Triangulation maximizes a minimum angle of all the angles of the triangles in the triangulation). This would ensure that the entire graph is triangulated. If it is a dense graph, it is highly likely that parts of the graph are already triangulated. The triangulation step will add additional edges to the graph. Each edge is stored with a marker to indicate that it does not belong to the original topology of the graph. The graph may also be converted into an n-sided polygonal shape where n is strictly greater than zero. The user selects this n, and a standard polygonalization method can be used.

If the graph is not triangulated, then the energy calculation and energy collapse rules only apply to triangulated regions of the graph.

The method includes defining an energy function to collapse irrelevant or unnecessary triangles. The user may define this energy or use a default energy functional shown in equation (9). Intuitively the energy functional represents the level of interest of a triangle. The lower the energy of a triangle, the more it means that the triangle is not very important, and could well be removed from the graph.

$${E}_{t} = {w}_{a} ( {A}_{t} ) + {w}_{f} ( {\sum }_{{e}_{i} ∈ E ( t )} {f}_{{e}_{i}} ) \qquad ( 9 )$$

In equation (9), Eₜ is the energy of triangle t, and Aₜ is the area of triangle t, and

$${\sum }_{{e}_{i} ∈ T} {f}_{{e}_{i}}$$

is the sum of the frequency f of each edge eᵢ in t. This frequency represents how frequently a process executed along that particular edge. The weights wₐ and w_{f} are affine weights, where wₐ is customizable by the user, but as default is set to be:

$${w}_{a} = \frac{1}{Avg ( {A}_{1} , … , {A}_{T} )} \qquad ( 10 )$$

Equation 10 indicates the inverse of the average area of all triangles (A₁, . . . , A_{T}) in the graph, where T is the total number of triangles in the graph. Equation (11) shows that w_{f} is dependent upon wₐ:

w_{f}=1−wₐ (11).

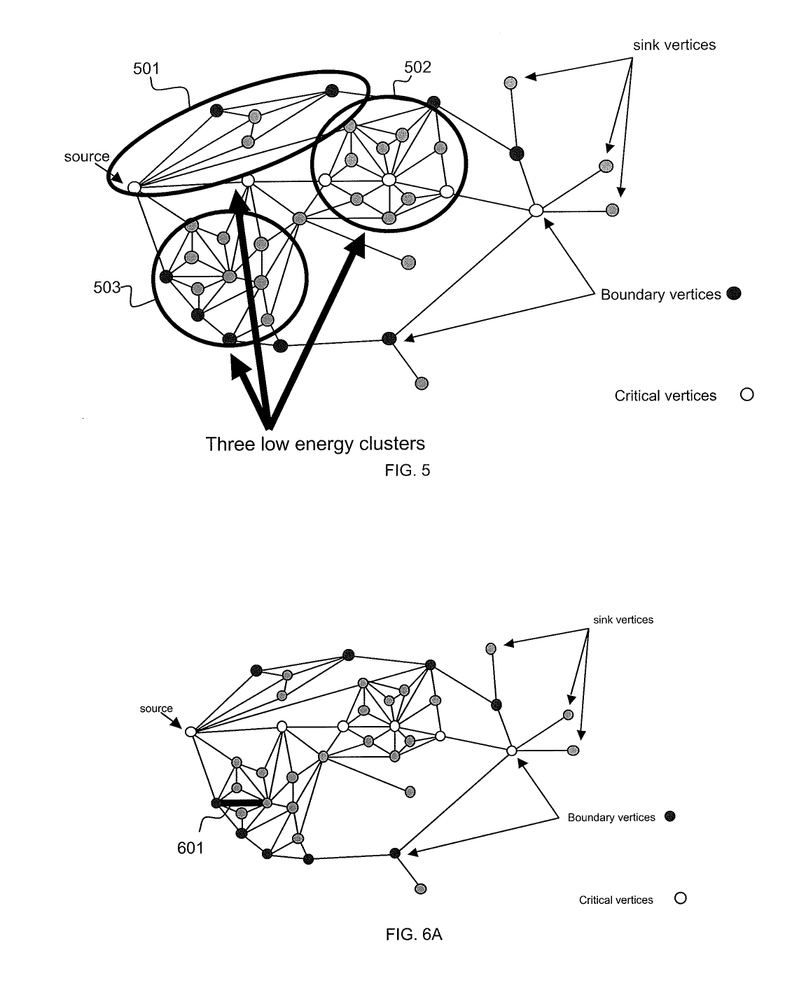

The triangle collapse-rule allows the storage of metadata about the collapsed triangle such that the triangle can be reconstructed if necessary. Referring to FIG. 3, the edge collapse transformation unifies two adjacent vertices v, 301a and vₜ 302 into a single vertex vₛ 301b. The vertex vₜ and the two adjacent faces {vₛ,vₜvₗ} and {vₛ, vₜ,vᵣ} vanish into the process.

The edge collapse transformation is invertible. The reverse of an edge collapse is a vertex split transformation. The vertex split transformation vsplit(s,l,r,t,A) adds near vertex vₛ a new vertex vₜ and two new faces {vₛ,vₜ,vₗ} and {vₛ,vₜ,vᵣ}. If the edge {vₛ,vₜ} is a boundary edge, we let vᵣ=0 and only one face is added. The attribute information denoted by A, includes other metadata such as the frequency of occurrence of the edge {vₛ,vₜ}, which edges are artificially added if the graph was triangulated.

Since the edge collapse transformations are invertible, we can therefore represent an arbitrary graph G as a simple graph G⁰ together with a sequence of n vsplit records:

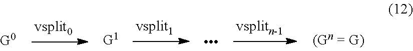

where each record is parameterized as vsplitᵢ(sᵢ,lᵢ,rᵢ,Aᵢ).

(G⁰,{vsplit₀, . . . , vsplitₙ₋₁}) is a progressive graph representation of G.

G⁰ is simpler than G¹ because it contains fewer vertices, edges and faces than G¹. However, the level of simplification between two consecutive graphs Gⁿ and Gⁿ⁻¹ does not necessarily follow a strict pattern of edge collapses. In particular each vertex in Gⁿ need not be collapsed in order to obtain Gⁿ⁻¹. Gⁿ⁻¹ may contain a number of edges, vertices and faces that are also present in Gⁿ. The level of simplification between two consecutive graphs could be arbitrary and user determined. Also, we do not assume that the entire graph Gⁿ is triangulated. Therefore the edge collapse rule is only applicable to areas in the graph with triangles.

A simplification method according to an embodiment of the present disclosure includes identifying low energy clusters and collapsing low energy triangles while observing critical edge constraints.

The identification of low energy clusters can be done by running depth first search on the graph, computing the sum of energy of adjacent triangle clusters in the r-ring of a vertex, where r is an integer greater than 0, and recording this information. The triangles in the 1-ring of a vertex v are the triangles which have at least one edge which is connected to v. Triangles in the 2-ring of a vertex v are triangles which have at least one edge which is connected to another triangle which has at least one edge connected to v. FIG. 2A shows an example of a 1-ring, 2-ring, and r-ring of a vertex. Vertices with a r-ring energy lower than an energy threshold E_{R(v)} are marked and stored, and serve as the input to a collapsing sub-method. r, which is the radius of the ring around the vertex is selected by the user.

As an alternative to the above method, a random number of r vertices may be selected, which serve as seeds for the simplification procedure in the collapsing sub-method. For each random vertex, an r-ring energy is determined, and if the r-ring energy is below the energy threshold Eₜ, the simplification procedure continues to the collapse of low energy triangles. This random selection of vertices takes constant time. The depth first search alternative takes O(|V|+|E|) time. The user may select either option.

To perform the collapse of low energy triangles, for each vertex selected in the identification, if the edge is not in the critical edge list, L_{c}, collapse an edge of a triangle whose energy is below an energy threshold Eₜ, where energy is defined as in equation (9). The edge selected to be collapsed should be adjacent to another triangle whose energy is below the energy threshold Eₜ. If all the triangles adjacent to a triangle have energy below energy threshold Eₜ, then it does not matter which edge is selected for collapse. Information for collapsed edges is stored in the form of vsplitᵢ(sᵢ,lᵢ,rᵢ,Aᵢ) data structures, as defined above. The user can customize the metadata to store in attribute A.

Using the progressive graph representation (G⁰,{vsplit₀, . . . , vsplitₙ₋₁}) of G, a user can move back and forth between different levels of detail of the graph. On a web 2.0 widget that displays the graph of a mined business process, and that responds dynamically to user mouse clicks, the user may highlight a vertex in the graph at level of detail Gⁿ and expand that area using the progressive graph representation dynamically to more-closely examine it.

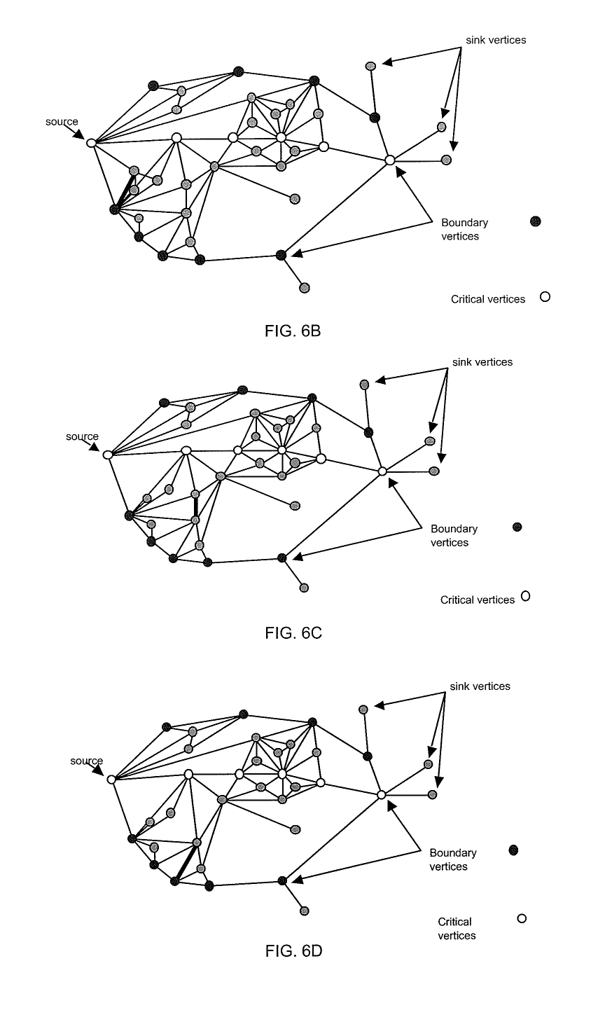

FIG. 4 depicts a method according to an exemplary embodiment of the present disclosure.

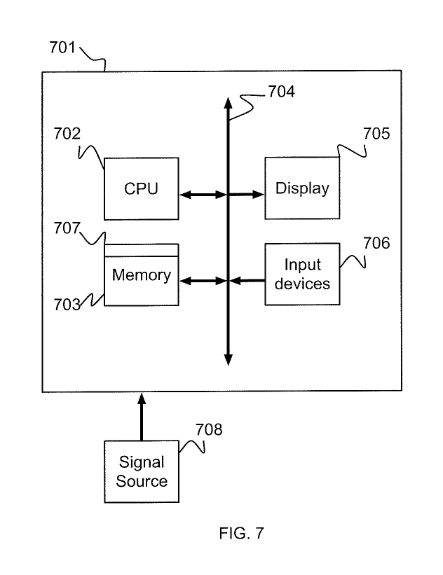

At block 401, a graph, G, is received as input. At block 402, G is parameterized using Tutte's algorithm to obtain an injective mapping where none of the edges overlap. Here, each vertex in G is assigned (x,y) coordinates. At block 403, critical edges of G may be marked and stored in list L_{c}. The critical edges may be input by a user and/or determined using a depth first search to find articulation points. At block 404, G may be triangulated, adding artificial edges to create triangles where triangles are not present. These artificial edges may be marked to distinguish them from the original graph topology. Total triangles in G are represented as list T. At block 405, an energy function Eₜ is defined for each triangle in T. At block 406, vertex clusters (node clusters) are identified, and for each cluster edges are collapsed using the edge collapse transformation rule that are not in the critical edge list L_{c}. At block 407, a resulting simplified graph is output (e.g., stored to memory, displayed by a monitor (see 705, FIG. 7), printed to a hardcopy, received as input to a program of executable code, etc.).

As shown in FIG. 4, a user may adjust the energy definition or change the critical edges based on the output at block 407. In this case the flow returns to block 403 (or blocks 404 or 405 depending on whether the critical edges are marked at block 403 and whether G is triangulated at block 404). Further, the flow between the collapse (block 406) and view (block 407) is an iterative process driven by user input, for example, received via an input device (706, FIG. 7) or a signal source device (708, FIG. 7).

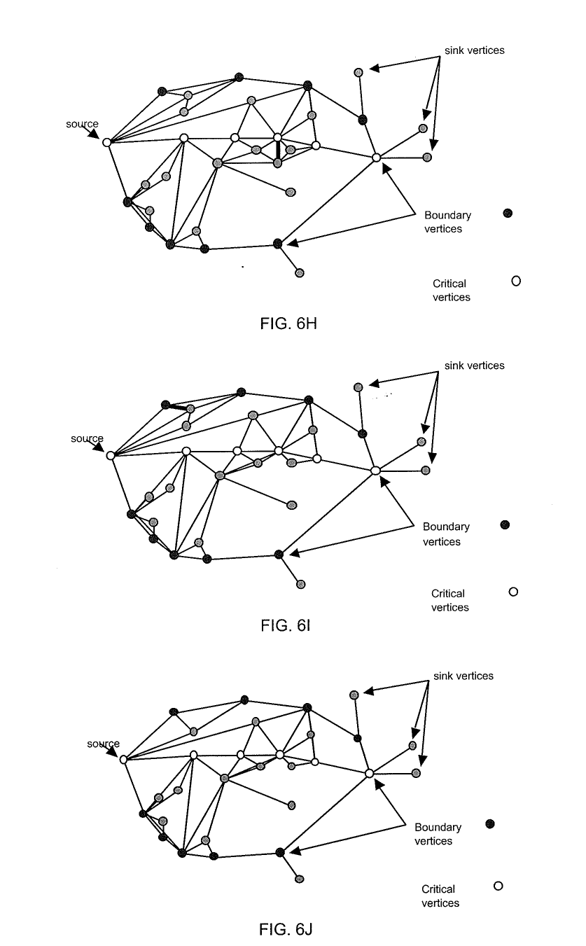

Given an input process graph G and the identified low energy clusters 501-503 (see FIG. 5), FIGS. 6A-J, show an example of the execution of the simplification algorithm on process graph G. In FIGS. 6A-J, a next edge to be collapsed is shown in bold, e.g., 601.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium (see 703, FIG. 7) may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium (703, FIG. 7) would include the following: an electrical connection having one or more wires (e.g., see bus 704, FIG. 7), a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to exemplary embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor 702 of a general purpose computer 701, special purpose computer, or other programmable data processing apparatus to produce a machine, such that the instructions, which execute via the processor 702 (e.g., Central Processing Unit or CPU) of the computer 701 or other programmable data processing apparatus, create means for implementing the functions/acts specified in the flowchart and/or block diagram block or blocks.

These computer program instructions 707 may also be stored in a computer readable medium 703 that can direct a computer 701, other programmable data processing apparatus, or other devices to function in a particular manner, such that the instructions stored in the computer readable medium 703 produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Having described embodiments for simplifying unstructured processes, it is noted that modifications and variations can be made by persons skilled in the art in light of the above teachings. It is therefore to be understood that changes may be made in exemplary embodiments of disclosure, which are within the scope and spirit of the invention as defined by the appended claims. Having thus described the invention with the details and particularity required by the patent laws, what is claimed and desired protected by Letters Patent is set forth in the appended claims.

What is claimed is:

1. A method comprising:
receiving a connected process graph having a plurality of edges and nodes;
parameterizing the connected process graph to determine a mapping in which none of the edges overlap;
defining respective energies for a plurality of triangles formed by the edges and the nodes in the connected process graph;
identifying node clusters in the connected process graph; and
collapsing, for each node cluster, ones of the edges and nodes in the connected process graph that are not critical edges or critical nodes according to the energies,
wherein the method is performed by a processor.

2. The method of claim 1, further comprising determining the critical edges and the critical nodes of the connected process graph, wherein the collapsing excludes the critical edges and the critical nodes.

3. The method of claim 2, wherein the critical edges and the critical nodes are determined by a depth first search to find articulation points in the connected process graph.

4. The method of claim 1, further comprising receiving the critical edges and the critical nodes as input.

5. The method of claim 1, further comprising assigning each node in connected graph (x,y) coordinates.

6. The method of claim 1, further comprising triangulating non-triangulated portions of the connected process graph by adding artificial edges.

7. The method of claim 6, further comprising:
creating a list of the artificial edges before the collapse; and
restoring the graph to a former connectivity based on the list.

8. The method of claim 1, wherein the energies encode how frequently a process is executed along each edge of the respective triangles.

9. A computer program product for rendering a connected process graph, the computer program product comprising:
a computer readable storage medium having computer readable program code embodied therewith, the computer readable program code comprising:
computer readable program code configured to receive the connected process graph having a plurality of edges and nodes;
computer readable program code configured to parameterize the connected process graph to determine an injective mapping where none of the edges overlap;
computer readable program code configured to define respective energy functions for a plurality of triangles formed by the edges and the nodes in the connected process graph;
computer readable program code configured to identify node clusters in the connected process graph; and
computer readable program code configured to collapse, for each node cluster, ones of the edges and nodes in the connected process graph that are not critical edges or critical nodes according to the energy functions.

10. The computer program product of claim 9, the method further comprising determining the critical edges and the critical nodes of the connected process graph, wherein the collapsing excludes the critical edges and the critical nodes.

11. The computer program product of claim 10, wherein the critical edges and the critical nodes are determined by a depth first search to find articulation points in the connected process graph.

12. The computer program product of claim 9, the method further comprising receiving the critical edges and the critical nodes as input.

13. The computer program product of claim 9, the method further comprising assigning each node in connected graph (x,y) coordinates.

14. The computer program product of claim 9, the method further comprising triangulating non-triangulated portions of the connected process graph by adding artificial edges.

15. The computer program product of claim 9, the method further comprising:
creating a list of the artificial edges before the collapse; and
restoring the graph to a former connectivity based on the list.

16. The computer program product of claim 9, wherein the energy functions encode how frequently a process is executed along each edge of the respective triangles.

17. A method for manipulating a connected process graph having a plurality of edges and nodes, comprising:
identifying node clusters in the connected process graph, wherein the connected process graph has an injective mapping where none of the edges overlap, and wherein at least one polygon formed by the nodes in the connected process graph is associated with an energy function;
selecting a node cluster of interest; and
collapsing, for the node cluster of interest, ones of the edges and nodes in the connected process graph that are not critical edges according to the energy function,
wherein the method is performed by a processor.

18. The method of claim 17, further comprising determining the critical edges of the connected process graph, wherein the definition of energy function takes the critical edges and the critical nodes as input.

17. The method of claim 18, wherein the critical edges and the critical nodes are determined by a depth first search to find articulation points in the connected process graph.

18. The method of claim 15, further comprising receiving the critical edges and the critical nodes as input.

19. The method of claim 15, further comprising assigning each node in connected graph (x,y) coordinates.

20. The method of claim 15, wherein a portion of the connected process graph is polygonized by adding artificial edges.

21. The method of claim 20, the method further comprising:
creating a list of the artificial edges before the collapse; and
restoring the graph to a former connectivity based on the list.

22. The method of claim 15, wherein the energy functions encode how frequently a process is executed along each edge of the respective polygons.
